(19) United States
(12) Patent Application Publication
(10) Pub. No.: US 2025/0318680 A1
(43) Pub. Date: Oct. 16, 2025

(54) DISPOSABLE CONTAINER TO PREVENT SPLATTER IN A MICROWAVE

(71) Applicant: Carl Goins, Walla Walla, WA (US)

(72) Inventor: Carl Goins, Walla Walla, WA (US)

(21) Appl. No.: 18/634,916

(22) Filed: Apr. 13, 2024

(51) Int. Cl. A47J 36/02; A47J 36/04

(52) U.S. Cl. CPC A47J 36/027; A47J 36/022; A47J 36/04

(57) ABSTRACT

A disposable container to receive a plate of food therein and to prevent splatter in a microwave, the disposable container including a main body to receive the plate of food therein, the main body including a plate receiving aperture disposed at a side portion of the main body, through which the plate of food is insertable, and a turntable aperture disposed at a front portion of the main body to correspond to a turntable of the microwave, such that the plate of food contact the turntable directly and turns along with a turning of the turntable while the main body remains stationary.

### BACKGROUND

### 1. Field

The present general inventive concept relates generally to a container, and particularly, to a disposable container to prevent splatter in a microwave.

### 2. Description of the Related Art

Cleaning a microwave oven often requires the use of caustic and corrosive oven cleaners that can pose health risks, which are not only harmful to direct users but to the environment, in addition to cleaning overall being a tedious and time-consuming process.

However, it is difficult to prevent food from popping and splattering while it is cooking within a microwave.

Therefore, there is a need for an alternative approach to maintaining a clean microwave.

There is also a need for a device that prevents food from splattering within a microwave.

### SUMMARY

The present general inventive concept provides a disposable container to prevent splatter in a microwave.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a disposable container to receive a plate of food therein and to prevent splatter in a microwave, the disposable container including a main body to receive the plate of food therein, the main body including a plate receiving aperture disposed at a side portion of the main body, through which the plate of food is insertable, and a turntable aperture disposed at a front portion of the main body to correspond to a turntable of the microwave, such that the plate of food contacts the turntable directly and turns along with a turning of the turntable while the main body remains stationary.

The disposable container may further include a plurality of perforations disposed at another side portion of the main body to allow for venting within the main body.

The main body may be constructed from at least one of foldable paper, silicone, and plastic.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a disposable container to prevent splatter in a microwave, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Plate 10
Food 11
Microwave 20
Turntable 21
Disposable Container to Prevent Splatter In A Microwave 100
Main Body 110
Plate Receiving Aperture 111
Turntable Aperture 112
Perforations 113
Auxiliary Splatter Guard 120

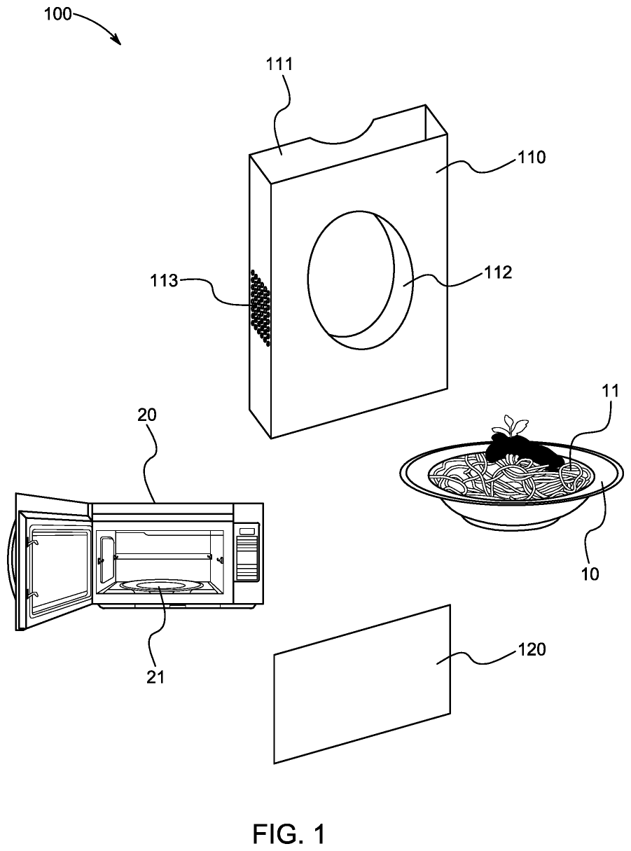

FIG. 1 illustrates a disposable container to prevent splatter in a microwave 100, according to an exemplary embodiment of the present general inventive concept.

The disposable container to prevent splatter in a microwave 100, and all components therein and/or connected thereto, may be constructed from at least one of paper, plastic, wood, silicone, glass, polyester, fabric, and rubber, etc., but is not limited thereto, and can be constructed from any material known to one of ordinary skill in the art that may be placed within a microwave. Also, although the disposable container to prevent splatter in a microwave 100 is meant to be disposable, the disposable container to prevent splatter in a microwave 100 may be reusable and washable, based on a manufacturer's preference and material from which the disposable container to prevent splatter in a microwave 100 is created.

Referring to FIG. 1, the disposable container to prevent splatter in a microwave 100 may include a main body 110 and an auxiliary splatter guard 120, but is not limited thereto.

The main body 110 may include a plate receiving aperture 111, a turntable aperture 112, and a plurality of perforations 113, but is not limited thereto.

The main body 110 may have a rectangular shape, but is not limited thereto, and may have a round, ovular, or any other type of shape desired by a manufacturer.

The plate receiving aperture 111 may be disposed at one side of the main body, and may be an opening that is large enough to receive a plate 10 (with food 11) therein.

The turntable aperture 112 may be an aperture that is designed to correspond to a turntable 21 of a microwave 20 (i.e., the microwave 20 is not drawn to scale in FIG. 1, but is included for illustrative and claim drafting purposes), such that the plate 10 disposed within the main body 110 may still contact the turntable directly. Accordingly, the plate 10 may turn within the microwave 20 while sitting atop the turntable 21, while the main body 110 remains stationary.

The perforations 113 may be disposed along various portions of the main body, and may be included to allow for even venting within the main body 110 while the food 11 disposed on the plate 10 is cooking.

As such, while the food 11 is cooking within the main body 110, the main body 110 may prevent any splatter from the food 11 from hitting internal walls of the microwave 20.

The auxiliary splatter guard 120 may have a temporary adhesive disposed on a surface thereof to allow the auxiliary splatter guard 120 to stick against a door or the internal walls of the microwave 20, to allow for extra splatter protection.

The present general inventive concept may include a disposable container 100 to receive a plate 10 of food 11 therein and to prevent splatter in a microwave 20, the disposable container 100 including a main body 110 to receive the plate 10 of food 11 therein, the main body 110 including a plate receiving aperture 111 disposed at a side portion of the main body 110, through which the plate 10 of food 11 is insertable, and a turntable aperture 111 disposed at a front portion of the main body 110 to correspond to a turntable 21 of the microwave 20, such that the plate 10 of food 11 contacts the turntable 21 directly and turns along with a turning of the turntable 21 while the main body 110 remains stationary.

The disposable container 100 may further include a plurality of perforations 113 disposed at another side portion of the main body 110 to allow for venting within the main body 110.

The main body 110 may be constructed from at least one of foldable paper, silicone, and plastic.

A purpose of the present general inventive concept is to simplify and transform the way users maintain the cleanliness of their microwave ovens. Ingenious and practical, the present general inventive concept offers an accessory that serves to simplify microwave oven cleaning, by offering a convenient, safe, and biodegradable option that eliminates the need for gloves and reduces exposure to toxic chemicals. The present general inventive concept introduces a novel biodegradable bag made of paper that serves as a barrier between the interior surfaces of the microwave and food. This budget-friendly solution eliminates the need for protective gear and simplifies the cleaning process, turning it into a hassle-free routine. With the present general inventive concept, maintaining a pristine microwave is as easy as inserting a bag, placing food within, and using the go-to kitchen appliance as normal, thus, this product provides a cost-effective and time-saving alternative. This innovative, top-quality product may benefit all individuals who seek to have a more convenient and efficient means of cleaning their microwave ovens and therefore may prove to be essential in the miscellaneous industry.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A disposable container to receive a plate of food therein and to prevent splatter in a microwave, the disposable container comprising:
a main body to receive the plate of food therein, the main body comprising:
a plate receiving aperture disposed at a side portion of the main body, through which the plate of food is insertable, and
a turntable aperture disposed at a front portion of the main body to correspond to a turntable of the microwave, such that the plate of food contacts the turntable directly and turns along with a turning of the turntable while the main body remains stationary.

2. The disposable container of claim 1, further comprising:
a plurality of perforations disposed at another side portion of the main body to allow for venting within the main body.

3. The disposable container of claim 1, wherein the main body is constructed from at least one of foldable paper, silicone, and plastic.
